(19) United States
(12) Patent Application Publication
(10) Pub. No.: US 2005/0198211 A1
(43) Pub. Date: Sep. 8, 2005

(54) Method and system of creating and transmitting multimedia content

(76) Inventors: Keon-Hwa Park, (US); Ki-Tae Hong, (US); Whan-Chul Kim, (US); Joo-Mun Lee, (US); Se-Hyun Oh, (US); Myung-Sung Lee, (US)

Correspondence Address: KUNZLER & ASSOCIATES, 8 EAST BROADWAY, SALT LAKE CITY, UT, 84111, US

(21) Appl. No.: 11/005,417

(22) Filed: Dec. 6, 2004

(30) Foreign Application Priority Data
Jul. 4, 2003 (KR) 10-2003-0021734

(51) Int. Cl. G06F 15/16

(52) U.S. Cl. 709/219; 709/203

(57) ABSTRACT

A method and a system of creating and transmitting multimedia contents are disclosed. The method is implemented in a multimedia content creating and transmitting system which includes a multimedia content producing/management server which can be connected with transmitting and receiving terminals through wired or wireless communication networks. The method comprises receiving a multimedia content constructing instruction through a communication networks, creating content according to the multimedia content constructing instruction, encoding the created content, and providing the encoded content to a receiving terminal through the communication networks. According to the method, various contents that correspond to various types of transmitting and/or receiving terminals can be produced, edited, converted, transmitted, received, and played back.

### CROSS-REFERENCES TO RELATED APPLICATIONS

This application claims priority to PCT Patent Application Number PCT/KR03/02699 entitled “METHOD AND SYSTEM FOR CREATING/TRANSMITTING MULTIMEDIA CONTENTS” and filed on Dec. 10, 2003 for SK Telecom Co., LTD and Entosys, which is incorporated herein by reference.

### BACKGROUND OF THE INVENTION

1. Field of the Invention

This invention relates to communication networks and more particularly relates to methods and systems for creating and transmitting multimedia contents through communication networks.

2. Description of the Related Art

Recent developments in multimedia technology have created a demand for a method and system for providing a multimedia content service accessible through a communication system such as a high speed Internet wired communication network or through a wireless communication network such as IMT 2000. In particular, specific functions such as transmitting or receiving photo images, moving (video) images, and music files such as MP3 files have been added to terminals, or connected to external apparatus, in a simple cellular phone. Such terminals, such as the IMT 2000 terminal, traditionally had been used only for transmitting and receiving voice and text.

Consequently the technical foundation is prepared whereby consumers can create multimedia content files by themselves and can transmit and receive the content files over the wireless communication network, thereby overcoming the time and spatial limits that have existed in the past. Several examples of representative prior art that utilize communication networks to transmit or receive multimedia content are discussed as follows.

Korean Patent No. 10-031154 (Application No. 10-1999-0043240), which was laid-open on May 7, 2001 and registered on Sep. 25, 2001, discloses a method of providing services by inserting multimedia contents comprising voice, music (or music video) during visual telephoning for the purpose of advertising a product of a certain company. The multimedia contents include images, sound clips, advertisement images and voices, such as photo images, moving images and so on, thereby providing advertisement opportunities to advertisers and reducing communication service rates for general users. However, this method does not make it possible to freely transmit a consumer's multimedia content to another consumer when the consumers are not communicating over a communication line, because the method inserts the predetermined advertisement content only when consumers are in vocal and visual telephone contact.

Korean Patent No. 10-0365862 (Application No. 10-1999-0055430), which was laid-open on Jul. 2, 2001 and registered on Dec. 10, 2002, discloses a method of embodying the function of music video in which, while music or melody is being provided in response to an incoming call, a portable wireless terminal indicates moving images relating thereto. However, although this method embodies the multimedia function by showing predetermined images simultaneously according to an incoming call, the method does not enable a consumer to make a multimedia file by himself/herself and to transmit it to another consumer.

Korean Patent No. 2002-0059194 (Application No. 10-2001-0000186), which was laid-open on Jul. 12, 2002, discloses a device for enabling a consumer to create a music video as a multimedia content file. In other words, it discloses a device for combining texts, photo images, and/or moving (video) images with music files according to selected design contents stored in a story board to create video files, which can be viewed as music video files. However, it does not present any method for enabling transmission/reception and regeneration of data through communication terminals (PDA or PC installing an IMT-2000 terminal with wireless transmitting/receiving capabilities) between consumers through wired and wireless communication networks.

Also, in order to transmit and receive the multimedia video files (which have been created by the aforesaid method) between consumers through the wire/wireless communication networks, new technology is needed such that a transmitting party can effectively compress and encode various files having different characteristics (text, image, music, and so on) such that a receiving party can effectively regenerate them. Further, since video files tend to contain relatively large amounts of information, consumers generally pay expensive communication rates when video files are transmitted or received. In addition, communication networks frequently become overloaded from transferring large media files. In particular, media file transfers typically create a considerable burden on the memory capacity of the receiving party terminal in downloading, storing and regenerating moving (video) images in wireless communication terminals.

From the foregoing discussion, it should be apparent that a need exists for a system and method that enable consumers to create multimedia content files by themselves through the multimedia content creating functions installed in or connected to a PC or a moving communication terminal, to transmit the multimedia content files to other consumers, and to easily receive and regenerate the multimedia content files through the receiving terminals. Beneficially, such a system and method would enable a transmitting party to create and transmit a multimedia content file, for example, using only photo image files. Accordingly, the receiving party, through benefit of the present invention, would be able to receive a moving (video) image based on the multimedia content file sent by the transmitting party.

### SUMMARY OF THE INVENTION

The present invention has been developed in response to the present state of the art, and in particular, in response to the problems and needs in the art that have not yet been fully solved by currently available systems and methods for communicating multimedia contents over communication networks. Accordingly, the present invention has been developed to provide a system and method for creating and transmitting multimedia content that overcome many or all of the above-discussed shortcomings in the art.

A system of the present invention enables users to create multimedia content by themselves and to transmit the content through a wired or wireless communication network to a receiving party. The system may embody a multimedia content producing/management server connected to transmitting terminals, receiving terminals, and other terminals through one or more communication networks. In one embodiment, the multimedia content producing/management server comprises a source content database, a source content designating code database, a server for exclusive use of content creating, an integrated central control/management module, and a server for exclusive use of transmitting.

In one embodiment, the integrated central control/management module controls the overall process to create multimedia content and to transmit the content to a receiving party. Consequently, the integrated central control/management module directs the server for exclusive use of content creating, which creates an integrated content by extracting the source content stored in the source content database according to a content constructing instruction, and directs the server for exclusive use of transmitting, which provides encoded integrated content (IMCF) to the receiving terminals.

In addition, the integrated central control/management module stores the source content received from the transmitting party to the source content database, creates a source designating code corresponding to the received source content, storing the created source designating code to the source designating code database, and creates an encoded integrated content (IMCF) by encoding the integrated content and providing the received content constructing instruction to the server for exclusive use of content creating. The server for exclusive use of content creating may also create a preview of the created integrated content to transmit to the receiving party according to a determined grade of the receiving terminal. Consequently, various types of terminals maybe used by the transmitting party and/or receiving party to create, edit, convert, transfer, and receive/regenerate various multimedia content files.

A method of the present invention is also presented for creating and transmitting multimedia content. In one embodiment, multimedia contents (hereinafter “content”) constructing instruction may be received through a communication network. Subsequently, an integrated content may be created according to the multimedia content constructing instruction. Next, the created content may be encoded and provided to the receiving terminal through the communication network.

According to an alternative embodiment of the present invention, a method of creating and transmitting multimedia content may comprise reserving at least one multimedia content (hereinafter “content”) source, securing a designated code for the at least one content source, obtaining the production option of the content through the transmitting terminal, creating a construction control code corresponding to the production option, and combining a source content designating code corresponding to the at least one source content with the construction control code to provide an integrated code. The method may further include creating integrated content according to the integrated code and storing the integrated content. In addition, the receiving/regenerating capacity (RSC) of the receiving terminal may be checked, and the encoded integrated content may then be transmitted according to the predetermined transmitting level and procedure of the checked RSC.

Consequently, a content creating management server may create a multimedia content and a preview of the content in response to a multimedia constructing instruction received from a transmitting party through a communication network. In certain embodiments, the multimedia content file may be made from content files and production options stored on the multimedia content producing/management server. The multimedia content producing/management server may then check the receiving/generating capacity (RSC) of a receiving terminal of a designated receiving party to determine the grade of the receiving terminal. Then the multimedia content may be transmitted to and regenerated by the receiving party.

As a result, the transmitting party may compile multimedia content using one or more terminals with varying capabilities and may send the multimedia content to a receiving party. The multimedia content producing/management server may construct a corresponding multimedia content file and may transmit the content file to a receiving party according to the grade of the receiving terminal. The receiving party, according to the terminal's grade, may benefit from receiving a multimedia content file.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter. dr

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram showing a multimedia content creating and transmitting system according to one embodiment of the present invention;

FIGS. 2 and 3 are flow chart diagrams showing the development process of the multimedia creating and transmitting method according to one embodiment of the present invention;

FIG. 4 is a block diagram illustrating one embodiment of a terminal which can be used in a transmitting party or a receiving party illustrated in FIG. 1;

FIG. 5 is a block diagram illustrating one embodiment of a content created by the system illustrated in FIG. 1;

FIGS. 6a to 11d are examples of page views for explaining the system illustrated in FIG. 1 and the methods illustrated in FIGS. 2 and 3;

FIG. 12 is a block diagram showing the multimedia content creating system according to another embodiment of the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

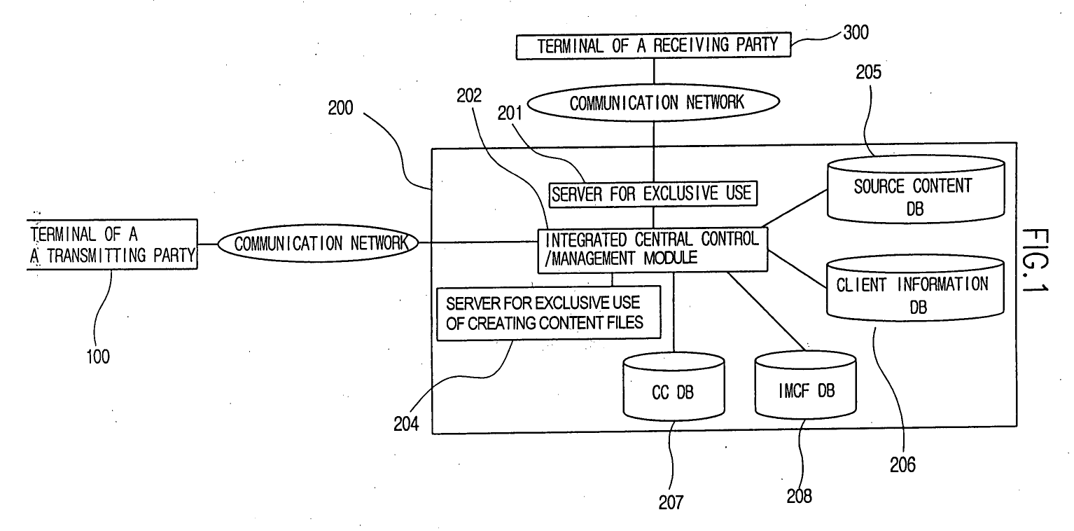

FIG. 1 is a block diagram showing a multimedia content creating and transmitting system according to one embodiment of the present invention. Referring to FIG. 1, the system for creating and transmitting a multimedia content according to the present invention is embodied by the multimedia creating, transmitting and managing server (200) which is connected to communication networks, e.g., Internet, mobile communication network, and PSTN. Business men, who operate communication networks, or service providers, who provide the multimedia service, can operate the multimedia creating, transmitting and managing server (200).

The multimedia creating, transmitting and managing server (200) creates integrated multimedia content files (IMCF; hereinafter “content files”) according to the request from the terminal of a transmitting party (100; hereinafter “transmitting party”) and provides the created content files (IMCF) to the terminal of a receiving terminal (300; hereinafter “receiver”). It is necessary to note that the content files (IMCF) may comprise text files (TF), moving image files (DF) and audio or video files (MF) according to the request from the transmitting party (100). When the creating, transmitting and managing multimedia server (200) receives a content constructing instruction (IC) from the transmitting party (100) connected through communication networks, it creates integrated multimedia content files (hereinafter, “content files”, “integrated contents” or “IMCF”) according to the content constructing instruction (IC). In addition, it provides the created content files (IMCF) to the receiving party (300). Herein, the transmitting party (100) and receiving party (300) may be respectively a moving terminal and a portable computer, e.g., PDA, notebook or personal computer.

The content constructing instruction (IC) comprises source designating instructions (TC, DC and MC) for designating at least one source contents (TF, DF and MF) in the content files (IMCF) and an attribute designating instruction (CC) for designating the connection attribute of the source contents (TF, DF and MF) which has been designated by the source designating instructions (TC, DC and MC). The content constructing instruction (IC) may be an integrated code (IC), which is a certain group of coded instructions. Thus, the content constructing instructions (IC; hereinafter “integrated code”) comprise a text designating code (TC) for designating the text files (TF), a photo designating code (DC) for designating photo files (DF), or an audio or moving image designating code (MC) for designating audio or video files (MF), and construction controlling (or, attribution designating) codes (CC) corresponding to the content files (IMCF) creating option (MCMO) or corresponding to the controlling instruction, in order to designate the combination attributions of each source content. Therefore, hereinafter, the terms “instruction” and “code” are used interchangeably for easier understanding of the present invention.

The multimedia creating, transmitting and managing server (200) stores the information of subscribers or clients of the services. For example, the multimedia creating, transmitting and managing server (200) stores the information regarding contents created by clients beforehand and information regarding the receiving party, communication cost and payment particulars. The multimedia creating, transmitting and managing server (200) stores created content files (IMCF).

The multimedia creating, transmitting and managing server (200) classifies the grade (e.g., grade of terminal capacity) of the receiving party (300). The grade of the receiving party (300) is granted according to at least one classification grade. Desirably, the at least one classification grade comprises at least one among the receiving capability, regenerating capability, and request level of the multimedia contents of the receiver (300).

Meanwhile, according to an embodiment of the present invention, the multimedia creating, transmitting and managing server (200) is capable of creating the preview content files before the content files (IMCF) are created and then providing the created preview content files to the receiver (300). In addition, in response to the reply of the receiver (300) to the preview content files, the server can create the content files (IMCF) and provide all or some predetermined parts of the content files (IMCF) to the receiver (300). On the other hand, according to another embodiment of the present invention, the multimedia creating, transmitting and managing server (200) creates content files (IMCF), and then creates preview content files thereof to provide the created preview content files to the receiver (300) before providing the content files (IMCF) to the communication networks. Subsequently, according to the reply to the preview content files from the receiver (300), the server provides the content files (IMCF) to the receiver (300). The present invention is not confined to the order of creating or providing the preview content files and content files (IMCF).

Still preferably, the content files (IMCF) comprise the information regarding a transmitting party (100), title of the content files (IMCF) and explanation thereof and messages. The transmitter's information, title of the content files (IMCF) and their explanation and messages may be generated from the transmitting party (100), or can be generated from the compilation of text information files provided to the transmitter (100) from the multimedia creating, transmitting and managing server (200). On the contrary to this, the title of the content files (IMCF) and explanation thereof, and messages can be created according to the program which has been prepared in advance in the multimedia creating, transmitting and managing server (200).

Preferably, as illustrated in FIG. 1, the multimedia creating, transmitting and managing server (200) comprises a server for exclusive use (201), an integrated central control/management module (202), a server for exclusive use of content files (IMCF) (204), source content database (DB; 205), clients related information database (206), construction controlling codes (CC) database (207) and IMCF database (208).

The server for exclusive use (201) provides the content files (IMCF) to receiver (300) under the control of the integrated central control/management module (202) through the communication networks.

The source content DB (205) stores source contents prepared in advance, e.g., source contents provided by external multimedia content service providing companies as well as those which a user uploaded.

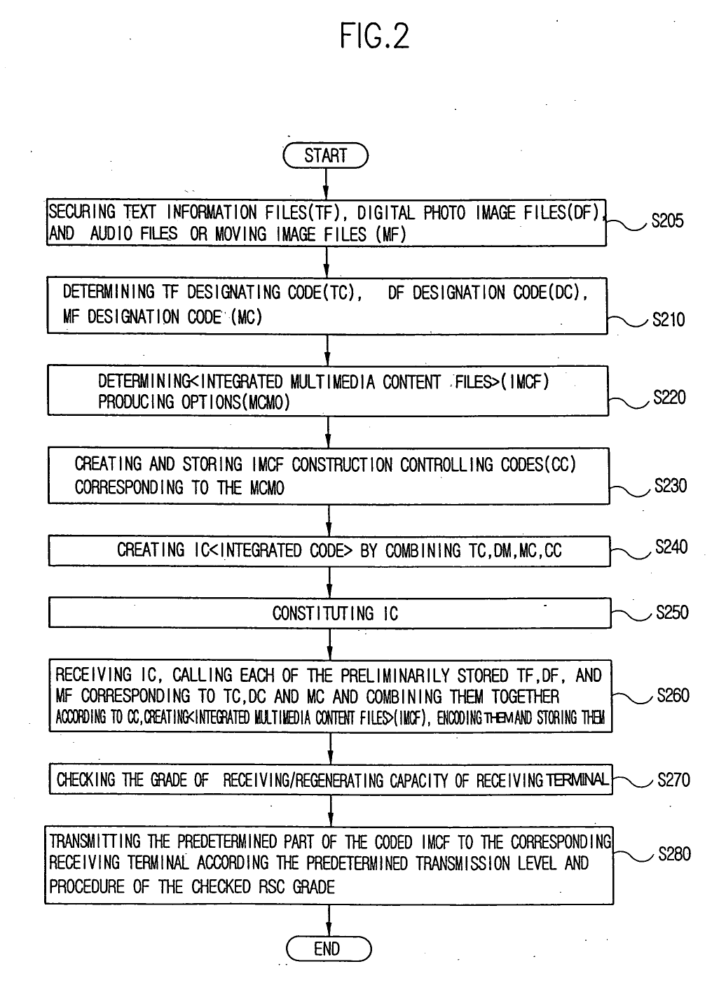

The integrated central control/management module (202) controls this system overall. The integrated central control/management module (202) provides the received content constructing instruction (IC) to the server for exclusive use of content creating (204), when the content constructing instruction (IC) is received through the content constructing instruction (IC) from the transmitter (100). Also, the integrated central control/management module (202) obtains source contents (refer to the step S205 of FIG. 2). The source contents may be those stored in the source content DB (205), or may be those provided through communication networks from the transmitter (100). For example, if the source contents transmit newly secured files from the transmitter (100) to the integrated central control/management module (202) of the multimedia creating, transmitting and managing server (200), the integrated central control/management module (202) stores the new files (TF, DF or MF) at the source content DB (205), gives (i.e., determines) the corresponding source designating codes (TC, DC or MC) (refer to the step S210 of FIG. 2), and if the source designating codes (TC, DC or MC) is stored at the construction controlling codes DB (207) simultaneously of transmitting the source designating codes (TC, DC or MC) to a transmitter (100), the user of the transmitting party (100) can check them.

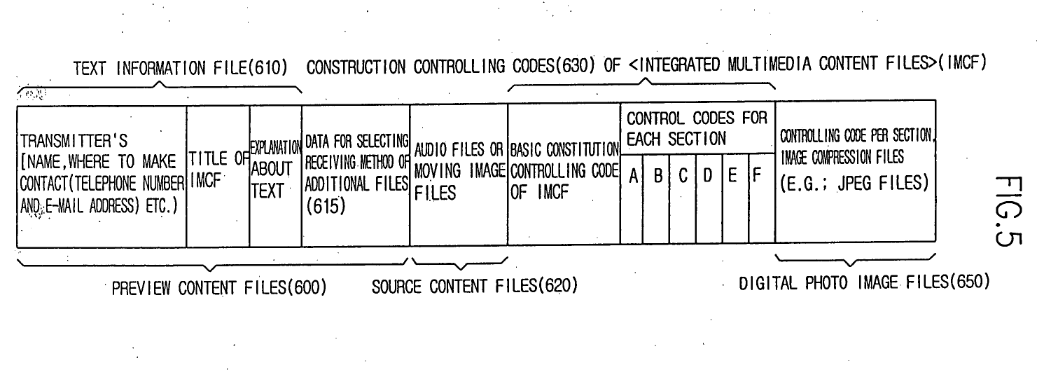

The server for exclusive use of creating IMCF (204) stores the construction controlling codes (CC) in advance, which fall under various creating options (MCMO), in the memory inside thereof, or is provided with those created by the integrated central control/management module (202) of the multimedia service management server (200) or those stored in the construction controlling codes DB (207), which have been created by the central control module (170) (refer to the step S230 of FIG. 2). The construction example of the content files (IMCF) according to the present invention is illustrated in FIG. 5. The construction of the content files (IMCF) illustrated in FIG. 5 is specifically explained hereinafter. Also, since the creation of the content programs can be easily embodied by a person skilled in the art based on the detailed description of the specification and is obvious to those skilled in the art, specific programs are not stated in the detailed description.

The central controlling module (170) creates an integrated code by combining TC, DC, MC, and CC together (refer to the step S240 of FIG. 2), and transmits the created integrated code (IC) to the integral central control/management module (202) (refer to the step S250 of FIG. 2). Then, if the integrated central control/management module (202) receives the integrated code (IC) and collects the source contents (TF, DF, and MF) corresponding to TC, DC, and MC in the IC from the source content DB (205) and provides them to the server for exclusive use of IMCF creating (204) along with the CC, the server for exclusive use of IMCF creating (204) combines the source contents together according to the CC and creates content files (IMCF).

Also, according to an alternative embodiment, the content files (IMCF) created by the server (204) for exclusive use of creating the IMCF are coded by the integrated central control/management module (202), converted to coded content files (IMCF) and can be stored in the IMCF DB (208) (refer to the step S260 of FIG. 2). In addition, in some embodiments, the central control/management module (202) can execute all of the functions of the server for exclusive use of creating IMCF, without installing the server for exclusive use of creating IMCF (204) in a device.

The client related information DB (206) stores the information of subscribers or clients of the services. For example, the client related information DB (206) stores identification information regarding clients (ID, password, telephone number, address and so on), information regarding previously created content files (IMCF), receiver's information, communication cost, and payment details. The IMCF DB (208) stores the content files (IMCF), which have been created by the server for exclusive use of creating IMCF (204), under the control of the integrated central control/management module (202).

The integrated central control/management module (202) classifies the grade of receiving/regenerating capacity of the receiver's terminal (300). The receiver's RSC grade classified by the integrated central control/management module (202) is given to the receiver (300) according to at least one classification standard. The at least one classification comprises at least one among the receiving capacity, regenerating capacity, and request level of the receiver (300).

In order to check and classify the grade of the receiver (300), the integrated central control/management module (202) gives and takes appropriate check signals with the receiver's terminal (300) designated by the receiver (300) and checks the RSC grade of the receiver's terminal (300) by referring to the kinds and capacity related information of the receiver's terminal (300) (refer to the step S270 of FIG. 2). In this case, when the information related to the kinds and capacity of the receiver's terminal (300) is registered in the client related information DB (206) in advance, the information will be referred to.

Examples of the RSC grade of the receiver's terminal (300) are as follows:

A) Grade being capable of receiving/regenerating every kind of content files (IMCF);

B) Grade being capable of receiving/regenerating only <text information files and moving image files> among the content files (IMCF);

C) Grade being capable of receiving/regenerating only <text information files and audio files> among the content files (IMCF);

D) Grade being capable of receiving/regenerating only <text information files> among the content files (IMCF); and

E) Grade supporting so called SMIL standard.

The integrated central control/management module (202) provides all or part of the coded IMCF according to the predetermined transmission level and procedure according to the grades through the server for exclusive use (201) to the receiver (300).

The integrated central control/management module (202) allows the server for exclusive use of creating IMCF (204) to create preview content files (e.g.: 600 of FIG. 5) [e.g., text information file (610 of FIG. 5)+data guiding the receiving method of additional files (615 of FIG. 5)] before transmitting coded content files (IMCF) to the receiver (300), codes them to create coded preview content files, transmits them to the receiver (300), and provides coded content files (IMCF) to the receiver (300) according to the reply of the receiver (300), e.g., service request.

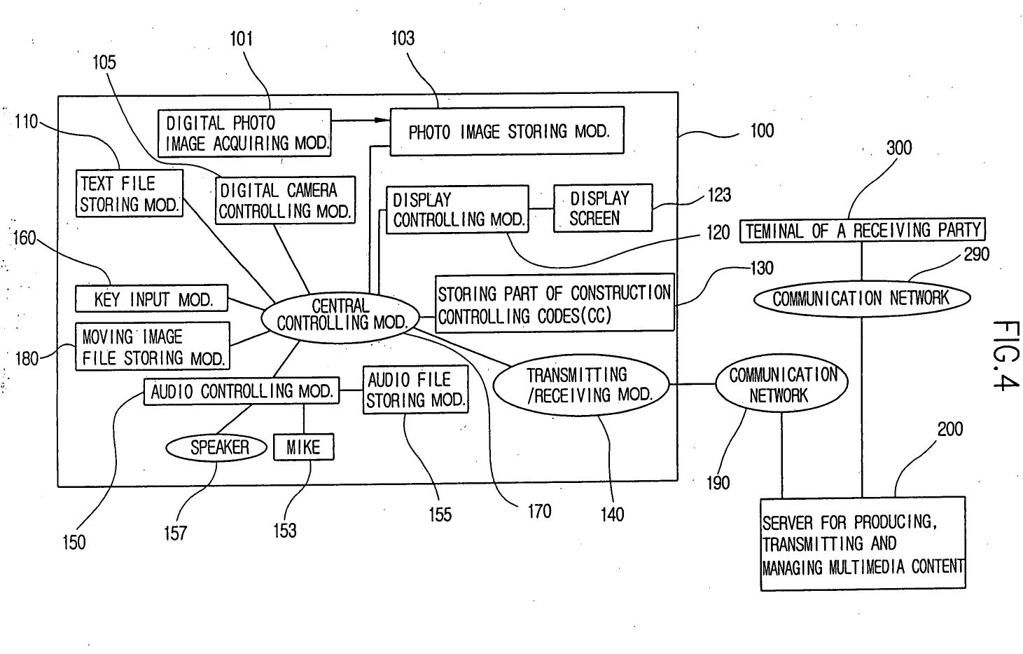

Examples of detailed constitution of the terminals (100, 300) which can be used for the transmitter's terminal (100) or for the receiver's terminal (300) are illustrated in FIG. 4. Referring to FIG. 4, terminals (100, 300) comprise a plurality of storing modules (110, 103, 155, 180, 130) for storing text files (TF), photo image files (DF), audio (music) or moving image files (MF), and controlling codes (CC). The terminals (100, 300) can show files stored in a plurality of storing modules (110, 103, 155, 180, 130) on a display (120, 123) according to the control of the central controlling module (170), and can output them through a speaker (157). The central controlling module (170) can interact with the server for multimedia creating, transmitting and managing through a transmitting/receiving module (140).

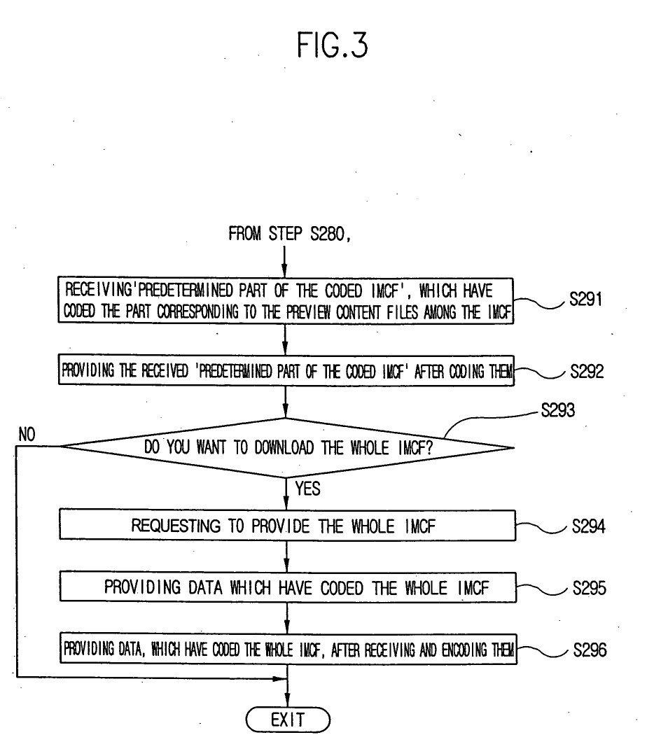

FIGS. 2 and 3 are flow chart diagrams showing the development process of multimedia content creating and transmitting according to an embodiment of the present invention. Hereinafter, we will provide detailed explanation about the development process of the multimedia creating and transmitting method by referring to the drawings attached hereto.

Firstly, in the step S205, when the user connects to the service system through the communication networks using his/her terminal (e.g.: 100) of the transmitting party, the integrated central control/management module (202) provides selecting and guiding data concerned with the content construction to the transmitter (100), and the user newly acquires them and transmits them to the creating, transmitting and managing multimedia server (200), or selects the source contents which are stored in the creating, transmitting and managing multimedia server (200) in advance, thereby securing source contents to be comprised in IMCF (S205).

For example, as illustrated in FIG. 5, the text information file (TF) necessarily comprises the transmitter's information and title of the IMCF to be prepared, and may further comprise a text message content (i.e., text explanation content) depending on the selection. It is common that the user inputs the title and the content of message through the key input module (160) of terminal (100), and text data are stored in the storing module (110) of text data of terminal (100). However, in some embodiments, the text information files may be the ones, which have downloaded previously stored text information files and have been edited by themselves and stored in the text file storing module (110), or may be the ones stored in the source content DB (205) of the creating, transmitting and managing multimedia server (200) in advance. Also, the text information files may be the ones receiving what other users transmitted and stored in the text information file storing module (110).

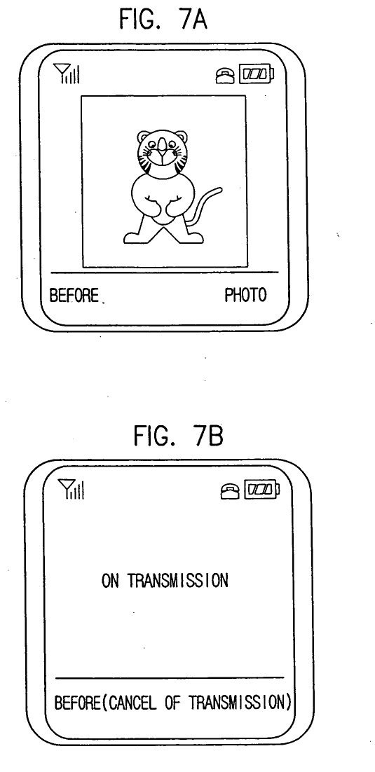

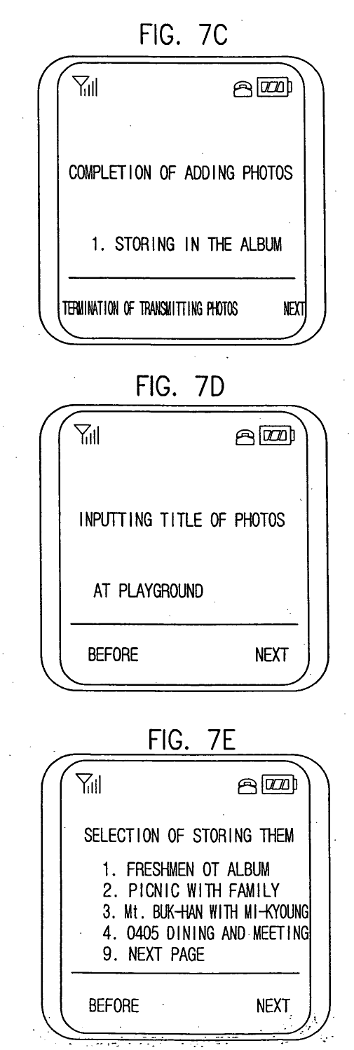

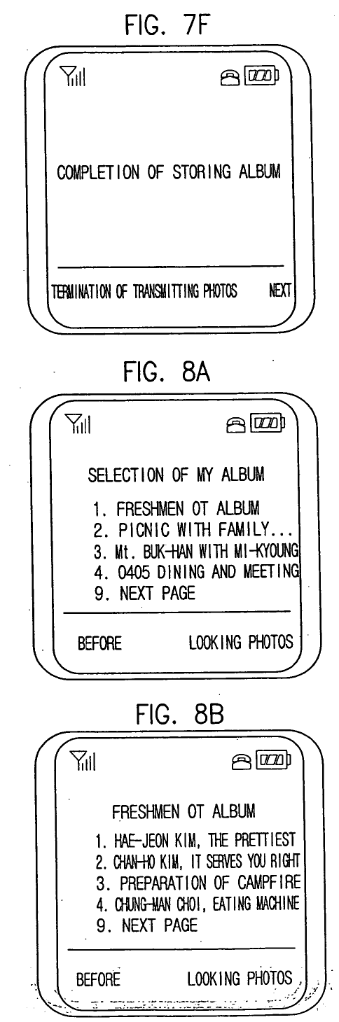

Usually, the digital photo image files (DF), as illustrated in FIG. 7a, are image files which are compressed and coded in a method of JPEG, GIF or other method. As another embodiment, the photo image files (DF) are generally acquired by a user with a digital camera. For example, photo image files (DF) are usually acquired by the digital image acquiring module (101) as a CCD device and stored in the photo image storing module (103) according to the manipulation signal selected by the user, under the control of the digital camera controlling module (105). However, it should be noted that according to some embodiments, only the digital photo image storing module (103) is installed in the transmitting terminal (100), but the digital photo image acquiring module (101) such as a digital camera controlling module (105) and a digital camera are not installed. In this case, photo image files may be stored in the source content DB (205) of the server for creating, transmitting and managing multimedia (200), or photo image files maybe stored in the photo image file storing module (103) after being downloaded and edited. Also, photo image files may be received from other users and stored in the photo image file storing module (103). Hereinafter, detailed explanation of the examples of the development process of securing the photo image files (DF) by referring to the drawings attached hereto will be provided.

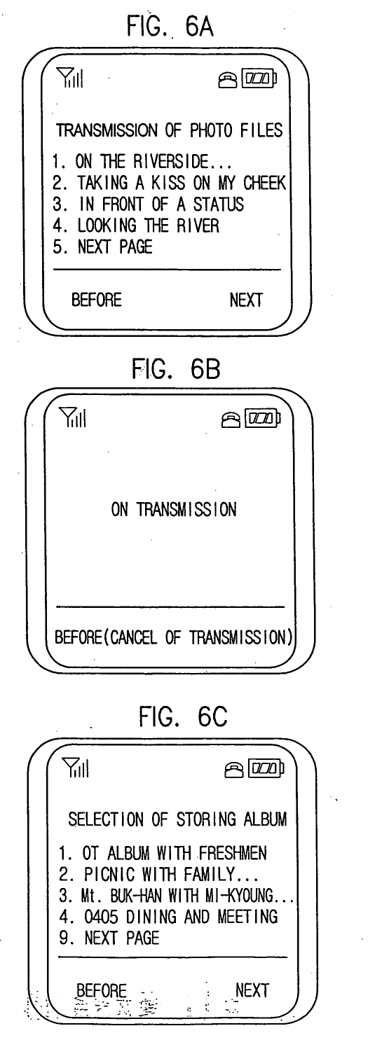

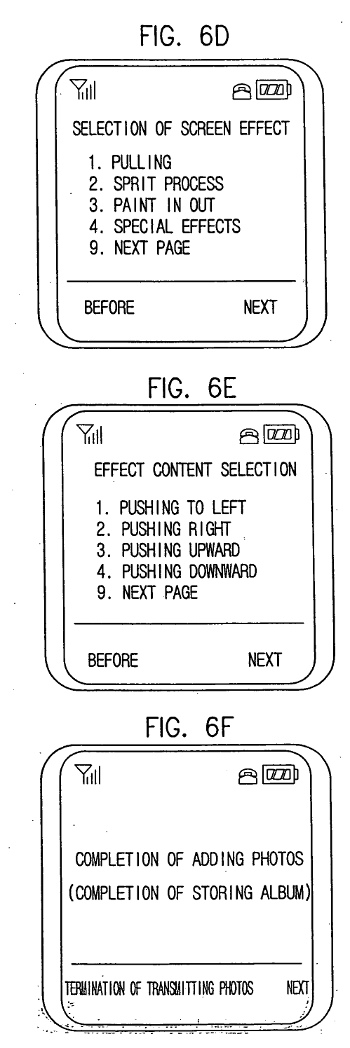

First of all, explanation about the photo image files (DF), which are stored in the transmitter's terminal (100) (i.e., the ones which have been stored previously or the ones stored by being received from the server for creating, transmitting and managing multimedia (200)) will be provided. As illustrated in FIG. 6a, if one of a plurality of selection items of photo images or moving images is selected, the server for creating, transmitting and managing multimedia (200) is provided through communication networks in order for the transmitter (100) to transmit photo image or moving image files (DF, MF) stored in the terminal (100) (i.e., the selected item, as illustrated in FIG. 6b). Then, the server for creating, transmitting and managing multimedia (200) stores the received photo image files (DF) at the position selected by the user (100), while providing a guiding menu, as illustrated in FIG. 6c.

Subsequently, the server for creating, transmitting and managing multimedia (200), as illustrated in FIG. 6d, provides a screen effect selection page, which can select the screen effect of the stored photo image or video files (DF, MF), to the transmitter. If the user of the transmitter (100) selects one of the plurality of screen effect selection items, the server for transmitting and managing multimedia (200) provides the effect content selection page in response to the selection to the transmitter (100), as illustrated in FIG. 6e. If the user selects one of the plurality of effect content selection items comprised in the effect content selection page, the selected item is stored, and a page informing the security of photo images or video files (DF, MF) is provided to the transmitter (100), and the process of securing photo images or video files (DF, MF) is completed, as illustrated in FIG. 6f.

As illustrated in FIGS. 7a-7f, if the photo image files (DF), which have been photographed immediately, are transmitted, the photo image files (DF) are provided to the server for creating, transmitting and managing multimedia (200) through communication networks. Also, if the user of the transmitter (100) selects or inputs the title and storage location, the server for creating, transmitting and managing multimedia (200) stores photo image files (DF) at the location selected and inputted by the user.

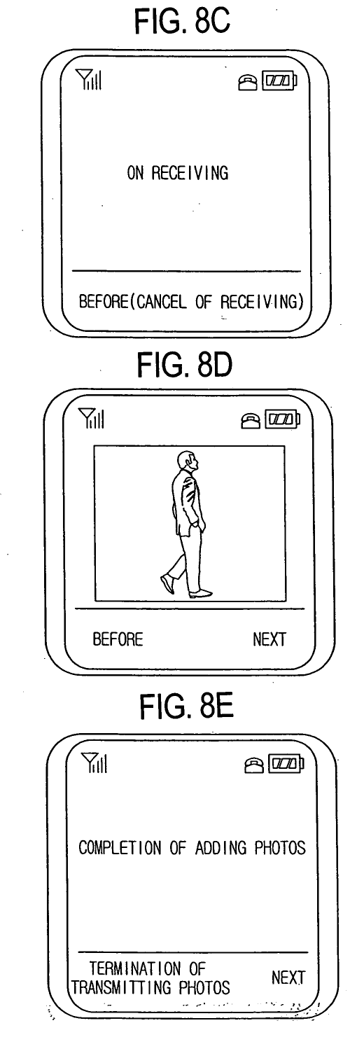

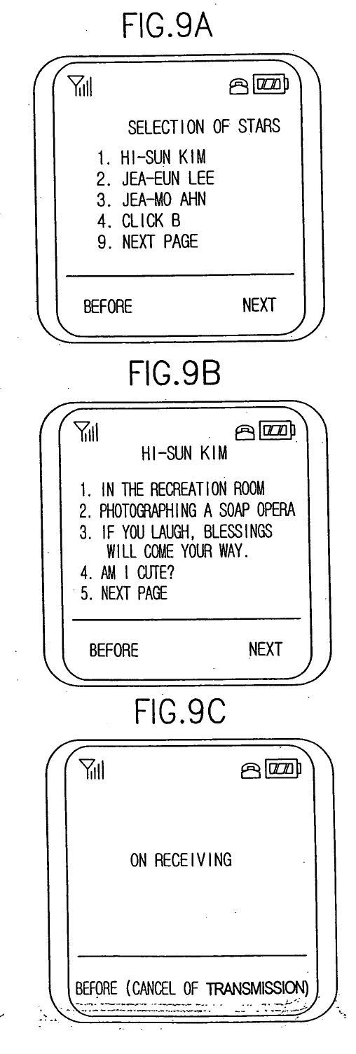

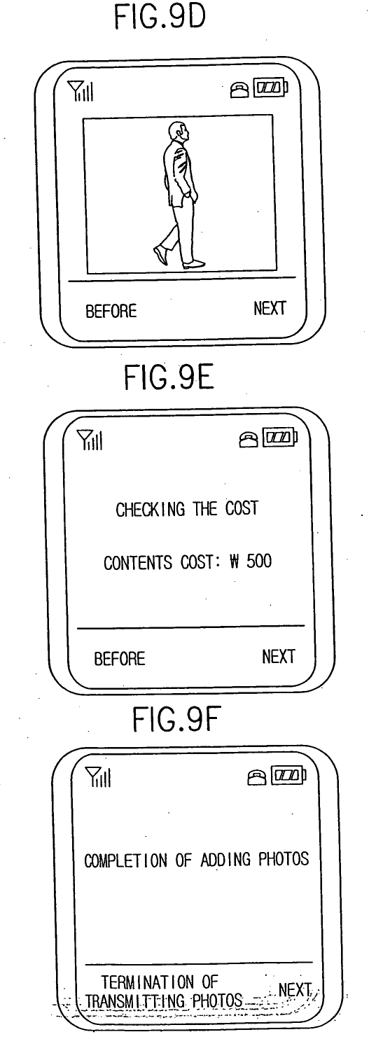

If sources are selected from the contents stored in the source content DB (205), the user, as illustrated in FIGS. 8a-8e, can determine photo image files (DF) by selecting the items corresponding to the source contents. Similarly, the photo image files can be provided to the public for a fee. As illustrated in FIGS. 9a-9f, the user of the transmitting party (100) selects the photo image files provided with a fee, so that he/she can obtain the photo image files (DF).

Regarding “audio files or video files (MF)”, the audio files typically contain human voices, sounds of nature, artificial songs or musical performances and so on. They are generally stored in the form of MP3 file or wave file. The video files are normally compressed with MPEG method. The audio files are normally acquired through a mike (153) under the control of the audio controlling module (150) of the transmitter (100) according to the user's manipulation signal, and stored in the audio file storing module (155), as depicted in FIG. 4.

However, in some embodiments, the audio files may be downloaded, edited as they are, which have been previously stored in the corresponding storage space [e.g., source content DB (205)] of the server for creating, transmitting and managing multimedia (200), and stored in the audio file storing module (155). Also, audio files may be stored in the audio file storing module (155) after receiving the files the other user transmitted.

Moving images, as used herein in the following detailed description and claims, generally mean audio files or images that comprise audio files. In other words, a moving image without audio is not desirable.

In addition, it should be noted that the terminal (100) does not necessarily require the moving file storing module (180) to apply the present invention, and the moving file storing module (180) may be implemented according to selection. In other words, considerable costs and loads on the communication lines are required to store or transmit/receive moving images for the present invention. Thus, it should be noted that it is not necessary that the terminal (100) comprise a moving image acquiring device. Furthermore, an audio file instead of a moving file may be used as a background content file of the multimedia content files.

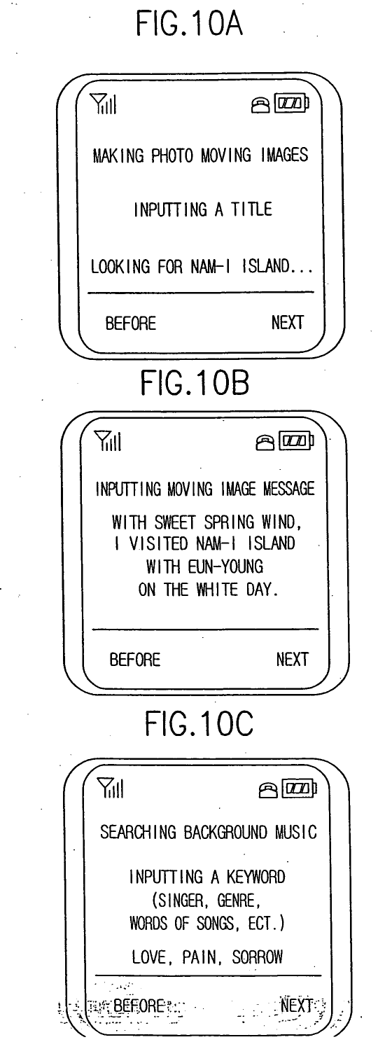

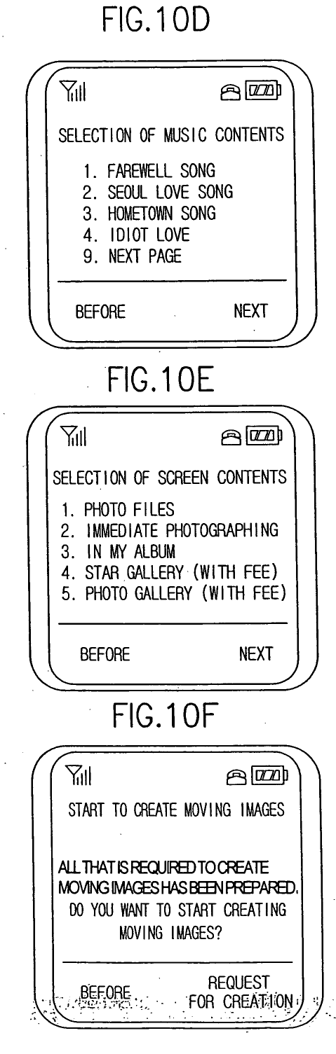

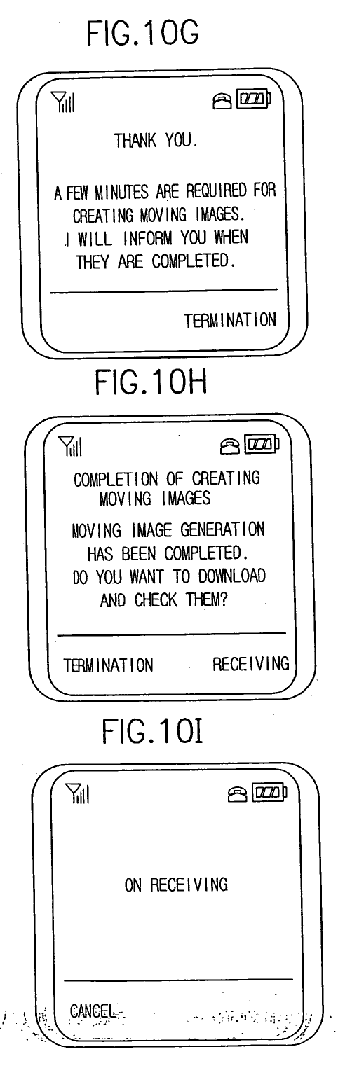

An example of the process of creating the aforesaid IMCF (expressed as “moving image files” in the example) will be explained by referring to FIG. 10a-10k hereinafter. If the user of the transmitting party (100) selects making moving image files, as illustrated in FIG. 10a, a title input page comprising a window for inputting the title of IMCF to be created by the transmitting party (100) is provided to the transmitting party (100). If the user inputs the title into the title input page, the server for creating, transmitting and managing multimedia (200) provides a moving message input page to the transmitter (100), as illustrated in FIG. 10b.

If the user inputs a message into the moving image message input page, the server for creating, transmitting and managing multimedia (200) provides to the transmitter (100) a background music searching page, with which music or moving images used for the background of the IMCF to be created can be searched, as illustrated in FIG. 10c. If the user of the transmitter (100) inputs a keyword of the music that he/she desires to the background music searching page, the server for creating, transmitting and managing multimedia (200) provides to the transmitter (100) a music content selection page comprising a list of music corresponding to the keyword, as illustrated in FIG. 10d. If the user of the transmitting party (100) selects music in the music list of the music content selection page, the server for creating, transmitting and managing multimedia (200) stores the selected music file.

Also, as illustrated in FIG. 10e, an image selection page, which permits the user to select the image source content, is provided to the transmitter (100). If the image source content is selected through the image content selection page, the server for creating, transmitting and managing multimedia (200) creates data guiding the process of creating moving images, as illustrated in FIGS. 10f-10i, and provides them to the transmitter (100). Then, the server for creating, transmitting and managing multimedia (200) provides the created moving images to the transmitter (100), as illustrated in FIGS. 10j, and allows the user of the transmitting party (100) to check the image files (MF) regenerated by the display controlling module (120) through a display screen (123).

Subsequently, in the step S210, the process required for determining designating instructions (or codes) TC, DC and MC, which respectively designate TF, DF and MF secured in the step S205 of the server for creating, transmitting and managing multimedia (200), is carried out. Designating instructions (or codes) TC, DC and MC may be obtained automatically, if the corresponding files and designating codes thereof are already stored in the source content DB (205) and construction controlling codes DB (207) of the server for creating, transmitting and managing multimedia (200). Also, if the user newly acquires a file, the transmitting terminal of the user sends the file to the server for creating, transmitting and managing multimedia (200), and the integrated central control/management module (202) stores the new file at the source content DB (205). Also, it grants a designating code thereof, and stores it at the construction controlling codes DB (207). At the same time, the designating code is transmitted to the transmitting terminal (100) of the user so that the user can check and access it. Meanwhile, it should be noted that the source content DB (205) is not only uploaded by the user, but may also be generally provided by external companies who provide contents services.

In step S220, the server for creating, transmitting and managing multimedia (200) carries out the process of determining integrated multimedia content files (IMCF) by creating options (MCMO) regarding how to combine the TF, DF or MF together, which have been designated in the step S210. The process may automatically determine <production option> by the user selecting one of the option menus which is prepared in advance in the design of the multimedia content creating and transmitting system, and may let the <production option> to determine by editing the input of the user.

The process for determining the production option can be carried out by the user by selecting the <production option> related menu displayed on a display screen (123) through the key input module (160), e.g., under the control of the display controlling module (120) of the terminal (100). Herein, the display screen (123) controlled by the display controlling module (120) may be, for example, an LCD window if the transmitting terminal (100) is a cellular phone or PDA, and a CRT monitor or LCD screen if the transmitting terminal (100) is a PC or digital TV. The display controlling module (120) executes overall display functions of displaying overall key manipulating menus selected by the user, or providing a screen showing all or a part of the production process of the integrated multimedia content file (IMCF) or the finishing point.

A person skilled in the art can easily understand that the central controlling module (170) of the terminal (100) can store and use previously promised protocol, overall information provided by service companies, and various prepared production option information in the multimedia content service system in the memory inside (not illustrated), thereby a necessary controlling action can be properly embodied. Also, the <production option> can have <designation of representative screen, control of the time length (ML) of moving images or audio files according to the text scroll speed (TLD) and regulations on ML and TLD>.

Specific example thereof is as follows:

1) Designating one of the representative screens (RP) among digital photo images.

2) In scrolling and showing text information on the screen of the terminal of the receiving party according to the predetermined speed, if the time length of moving images of integrated multimedia content files (IMCF) or audio files is too short to scroll all of the text information, the moving image or audio files are repeated again so that all of the text information can be scrolled. For example, if the regeneration (time) length of the text file (message) in the integrated multimedia content file (IMCF) is TL, the (time) length of selected music files or moving image files is ML, and the (time) length of regeneration of the constructing option is DL, the greatest length of time designated among the 3 (time) lengths being regenerated. If TL is short, it plays to the end without text scroll. If ML is short, it replays music files and moving image files from the beginning. If DL is short, it also plays to the end in the manner of repeating the regeneration of photo images and constructing option from the beginning.

3) Inserting the title of the integrated multimedia content files (IMCF) into the predetermined position of the terminal of the receiving party and constructing the first screen to show <from Mr./Ms. OOO, *** titled message has arrived to you>, and if the user checks it, explanation thereof is provided.

4) After text explanation is provided, data guiding the selection of the receiving method of additional files (e.g., preview, download, etc.) are provided. It can also contain simple sampling contents of IMCF such as ‘representative image (photo screen) with music for about 3 seconds’ or ‘moving image for about 5 seconds’.

5) If a download menu is selected by the user, photo images are sequentially displayed in the predetermined order (e.g., if the number of photos is less than 3, it shows each one for 30 seconds at the longest, and repeatedly shows them sequentially).

6) The display method of the photo image, which has been predetermined, applies as a predetermined effect, e.g., the effect of twirling appearance from the left comer to the central part of the existing screen with size getting bigger or pushing the previous screen gradually.

7) Meanwhile, the text explanation content maybe in the form of each photo screen or may be in the form of a poem or other writing. The content shows the explanation by inserting it onto the photo image (all or part) by constituting a photo screen and another screen according to the predetermined method.

Based on the aforesaid explanation about <production option>, a person skilled in the art can sufficiently embody the production option variously within the extent that the condition on the hardware system or service protocol allows. Thus, no further explanation about another example of <production option> will be provided. As explained hereinafter, integrated multimedia content files (IMCF) are created according to a desirable embodiment, as illustrated in FIG. 5, according to the aforesaid production option.

In step S230, the construction controlling codes corresponding to the production option (MCMO) are created (S230). The construction controlling codes (CC) are created by the central controlling module (170) of the terminal (100) according to the option selection of the user, are stored in the construction controlling codes storing module (130), and can be provided to the integrated central controlling/managing module (202) of the server for managing multimedia service (200). For example, the central controlling module (150) stores CC corresponding to various production options in advance, or is provided with the CC from the integrated central controlling module (202) of the server for managing multimedia service and can create the CC according to the predetermined programs. Regarding this, a person skilled in the art can easily embody it, so no further explanation thereof will be provided.

The control code (CC) indicated with reference number “630” in FIG. 5 comprises a control code per section in addition to the basic constitution controlling code of the integrated multimedia content files (IMCF). Herein, section means a length providing a photo image. Detailed constitution methods of each section may be different from each other. Thus, FIG. 6 exemplifies control codes of each section as A-F. Particularly, with this method, when the transmitter produces and transmits multimedia content files with photo image files only, the receiver can obtain the effect of moving images.

In step S240, the central controlling module (170) or integrated central controlling/managing module (202) creates an integrated code (IC) by combining the TC, DC, MC, and CC together.

In step S250, for example, the central controlling module (170) provides the integrated code (IC) to the integrated central controlling/managing module (202) of the server for managing multimedia service through the transmitting/receiving module (140) and communication networks (190). A person can easily understand that if the integrated code (IC) is created in the integrated central control/management module (202) of the server for managing multimedia service in another embodiment, the step S250 can be omitted.

In step S260, the integrated central controlling/managing module (202) in the server for creating, transmitting and managing multimedia (200) receives the integrated code (IC) and calls each of TF, DF and MF, which are stored in the source content DB (205) corresponding to TC, DC, and MC and provides them to the server for exclusive use of creating the IMCF. Meanwhile, the server for exclusive use of producing the IMCF (204) combines TF, DF, and MF together according to CC to create content files (IMCF), and the integrated central controlling/managing module (202) receives them and codes them. The coded content files (IMCF) are stored in the IMCF DB (208).

In step S270, the integrated central controlling/managing module (202) communicates proper checking signals with the receiving terminal (300) of the receiving party (300) designated by the transmitting party (100), and checks the grade of multimedia receiving/regenerating capacity (RSC) of the receiving terminal (300) by referring to the information of kinds and capacity related information of the receiving terminal (300). At this time, if the information regarding the kinds and capacity related information of the receiver's terminal (300) is registered in advance in the client related information DB (206) (or in the integrated central control/management module (202)), the information will be referred to.

In step S280, a given part (all or part) of the IMCF coded according to the transmission level and procedure of the checked RSC grade is transmitted to the receiver's terminal (300) by the server for exclusive use (201), if an integrated central control/management module (202) (or server for exclusive use (201)) in the server for creating, transmitting and managing multimedia (200) exists. For example, (the integrated central control managing/controlling module (202)) the server for creating, transmitting and managing multimedia (200) stores in advance <predetermined coded part of the IMCF> corresponding to the RSC grade (e.g.: A-E of 4-5> and <predetermined coded part of the IMCF> corresponding to the “text information file+guiding data selecting the method of additional files> as “preview content files” (e.g., in the server for exclusive use of producing IMCF). It should be also noted that the <predetermined coded part of the IMCF> corresponding to the preview content files is transmitted irrelevant to the RSC grade of the transmitter (300), and the <predetermined coded part of the IMCF> according to the grade of the terminal of the transmitting party (or the service requesting level from the terminal of the transmitting party) can be provided.

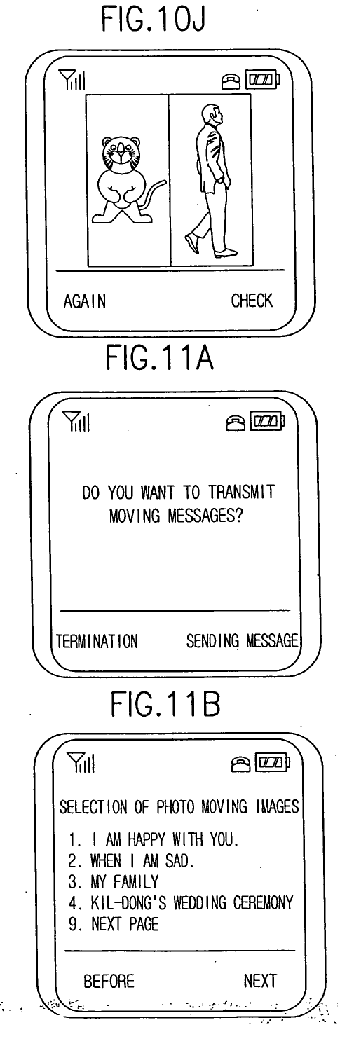

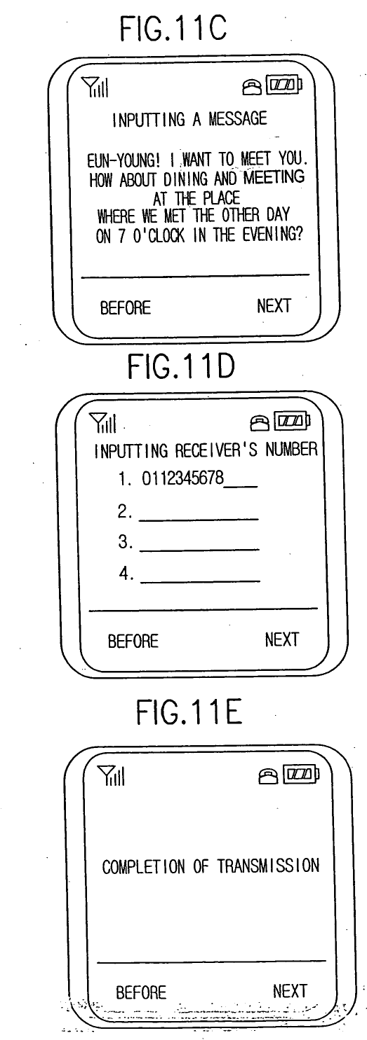

Explanation about one example of the process transmitting the IMCF created/stored by the aforesaid steps S205-S260 or the <predetermined part of the coded IMCF> by referring to FIGS. 11a-11d is as follows. When the user connects to the server for creating, transmitting and managing multimedia (200) in order to transmit the content files (IMCF), which are produced and prepared by the user in advance, the server for creating, transmitting and managing multimedia (200), as illustrated in FIG. 11a, provides a page for selecting a photo moving image that is a variety of the IMCF to the transmitter (100) and managing multimedia (200). If the user using the transmitter (100) selects the items of the source contents that he/she wants from among the moving image selection pages having the items corresponding to the IMCF secured by the moving image list comprised in the moving image selection page, i.e., by the steps S205-S270, the server for creating, transmitting and managing multimedia (200) in response to the selection temporarily stores the selected IMCF in the memory, and the transmitter (100) may provide a message input page having a message input window, as illustrated in FIG. 11b.

If the user using the transmitter (100) inputs his/her desired message into the message input window, the server for creating, transmitting and managing multimedia (200) stores the message, while providing the address of the receiving party (300) to receive the message, e.g., a wire/wireless telephone number and an address input page having an address input window for inputting an e-mail address or IP address to the transmitting party (100). If the transmitting party (100) inputs the address of the receiving party (300), the server for creating, transmitting and managing multimedia (200) creates the content files (IMCF) based on the selected IMCF and the inputted message, and then transmits the files to the address.

Hereinafter, referring to FIG. 3, the response according to the preview content file reception of the receiving party (300) and the transmission process of the content files (IMCF) of this system will be explained.

In step S291, when the receiving party (300) receives the <predetermined part of the coded IMCF>, which coded the preview content files, through communication networks from the server for creating, transmitting and managing multimedia (200), in the step S292, it decodes and regenerates the <predetermined part of the coded IMCF>.

In step S293, the process is performed according to whether or not the user of the receiving party (300) wants to download the whole content files (IMCF). The server for creating, transmitting and managing multimedia (200) performs the process by receiving the selection signals generated from the receiving party (300) according to the selection of the user of the receiving party (300).

In step S293, if the answer of the receiving party (300) is “NO”, the process is finished. If the answer is “YES”, the next step S294 is performed, wherein the integrated central controlling/managing module (202) of the server for creating, transmitting and managing multimedia (200) receives the request for providing the whole content files (IMCF) to the receiving party (300).

In step S295, the integrated central controlling/processing module (202) (or server for exclusive use (201), if any) of the server for producing, transmitting and managing multimedia (200) provides data which have coded all of the IMCF to the receiving party (300) through communication networks.

Then, the receiving party (300) encodes the data, which have coded all of the IMCF, regenerates the corresponding content files (IMCF) through the corresponding outputting device of the receiving party (300; not illustrated), and displays them. Thereby, the process is completed.

Some embodiments of the preview content files may include text information files (e.g., 610 of FIG. 5) and partial moving image information. Other embodiments may include only text information, or may include photo image files used for text information files as a representative screen. The terminal (300) of the receiving party desirably has the same structure as the terminal (100) of the transmitting party. Though the terminal (300) could be one of the various terminals corresponding to one of the aforesaid grades in some embodiments.

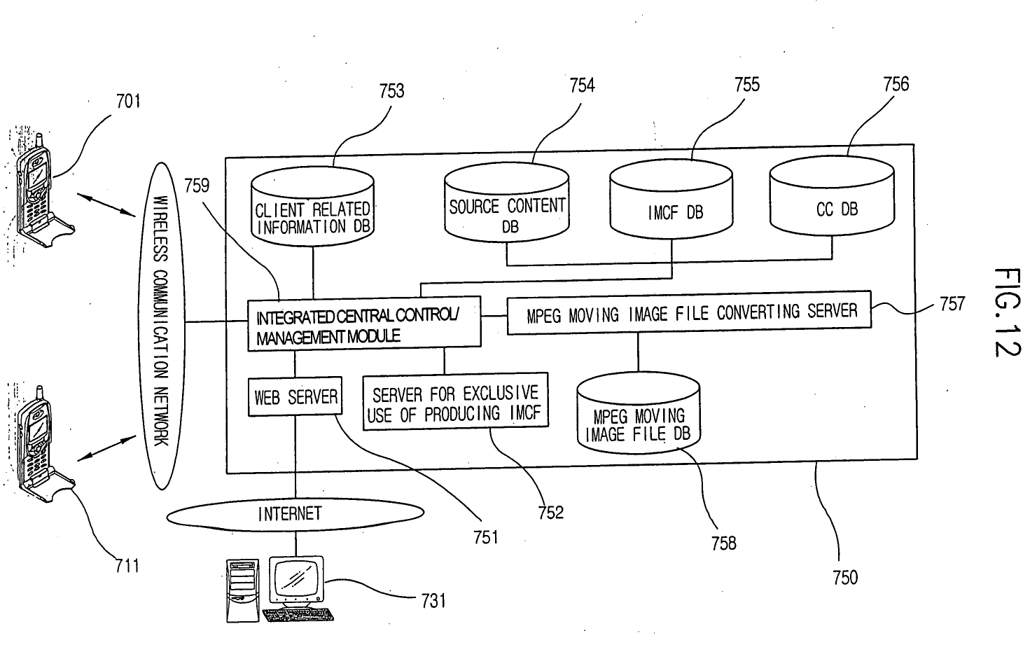

Hereinafter, we will explain the multimedia content service system according to a second embodiment of the present invention by referring to FIG. 12. Specifically, we will explain the differences between the multimedia content service system (hereinafter “second system”) according to the second embodiment of the present invention illustrated in FIG. 12 and the system (hereinafter “first system”) according to the first embodiment according to the system illustrated in FIGS. 1 and 4. Among the parts illustrated in FIG. 12, the same terms as those referred to in FIGS. 1 and 4 have the same structure and same work function, so the explanation thereof will be omitted.

In FIG. 12, reference numbers 701 and 711 are related to mobile communication terminals with multimedia content producing and transmitting service. Reference number 731 relates to a PC. Unlike FIG. 4, the server for managing multimedia service (750) in FIG. 12 further comprises a web server (751), an MPEG moving image file converting server (757), and an MPEG moving image file DB (758).

In the second system, after securing a text information file, a digital image file, audio or moving image and uploading the files through wireless communication networks to be stored in the source content DB (754) in a mobile communication terminal (701), the user can connect to the web server (751) of the server for multimedia producing, transmitting and managing (750) through his/her own PC (e.g., PC (731)) at home or elsewhere and can do necessary editing or the like using the editing menu provided by the <second system> and can input data (for adding or for changing). Herein, multimedia source contents provided from external multimedia producing companies and the like are prepared. As a result, multimedia content files prepared in advance and stored in the source content DB (754) can be provided according to the selection of the user.

In addition, for example, the mobile communication terminal (711) of the other party designated by the user of mobile communication terminal (701) (hereinafter “receiver”) as a receiving terminal may be a type of terminal that supports a moving image regeneration service. At this time, for example, the MPEG moving image file converting server (757) can convert the content files (IMCF) to MPEG method (e.g., MPEG-4), can create MPEG moving image files, can store them in the MPEG moving image file DB (758), and can transmit the corresponding MPEG moving image files to the receiver's terminal (711).

In addition, although FIG. 7 does not illustrate them, to be linked with the existing multimedia content service, the constitution of the MPEG4 moving image file converting server (757) can be improved or can be provided with various DB linked with other DB that are constituted separately from the MPEG moving image file converting server (757) (e.g., moving image mail DB, live screen DB, moving image gallery DB), and provides a converting server which makes the SML multimedia service to be linked with it. Thus, the second system can produce, edit, convert, transmit, receive and regenerate the multimedia content files of various types of formats corresponding to the various types of the terminals of the transmitting party and/or receiving party.

As explained above, according to the present invention, the user produces multimedia content files by himself/herself through the server for managing multimedia service and transmits the files to another user. With a terminal, the user can receive the multimedia contents by adjusting the files to his/her terminal capacity, regenerate them, and benefit from them. In particular, the multimedia content files can be produced by the transmitting party with only the simple form of a message (text file). The receiving party provides the method and system for producing and transmitting multimedia content, which enables the contents to be like moving images. Further, corresponding to the various types of terminals of the transmitting party and/or receiving party, various types of multimedia content files can be produced, edited, converted, transmitted, received and regenerated.

Overall, according to the present invention, the method and system of producing and transmitting multimedia contents can be realized, whereby the user can produce multimedia contents by himself/herself, and transmit them through wire/wireless communication networks.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of creating and transmitting multimedia content via a multimedia content producing/management server which can be connected with transmitting and receiving terminals through wired or wireless communication networks, the method comprising:
receiving a multimedia content (hereinafter “content”) constructing instruction through a communication network;
creating content according to the multimedia content constructing instruction;
encoding the created content; and
providing the encoded content to the receiving terminal through the communication network.

2. The method of claim 1, wherein the multimedia content constructing instruction includes a source designator for designating at least one content source used to construct the multimedia content.

3. The method of claim 1, wherein the content constructing instruction includes an attribute designator for designating at least one joining attribute used to construct the multimedia content.

4. The method claim 2, wherein the at least one content source is selected from the group consisting of a text information file, a photo image file, an audio file, and a moving (video) file.

5. The method of claim 1, wherein a grade is assigned to the receiving terminal according to at least one classification standard selected from the group consisting of a receiving capability, a regenerating capability, and a requested quality standard associated with the receiving party of the receiving terminal.

6. The method of claim 5, further comprising transmitting the encoded content according to the grade of the receiving terminal.

7. The method of claim 1, wherein the content includes information selected from the group consisting of transmitting terminal information, a title, an explanation, and a message.

8. The method of claim 7, wherein the information is provided by the transmitting party.

9. A method of creating and transmitting multimedia content via a multimedia content producing/management server which can be connected with transmitting and receiving terminals through wired or wireless communication networks, the method comprising:
reserving at least one multimedia content (hereinafter “content”) source;
securing a designated code for the at least one content source;
securing the production option of the content through the transmitting terminal;
creating a construction control code corresponding to the production option;
combining a source content designator corresponding to the at least one source content with the construction control code to provide an integrated code;
creating integrated content according to the integrated code;
encoding and storing the integrated content;
checking a receiving/regenerating capacity (RSC) of the receiving terminal, wherein the RSC of the receiving terminal is granted according to at least one classification standard, and the at least one classification standard is selected from the group consisting of a receiving capability, a regenerating capability, and a requested quality level associated with the receiving terminal; and
transmitting the part of the integrated content which has been encoded according to the predetermined transmitting level and procedure of the checked RSC.

10. The method of claim 9, wherein the class of the receiving terminal is granted to the receiving terminal according to at least one classification standard, and the at least one classification standard is selected from the group consisting of a receiving capability, a regenerating capability, and a quality level requested by the receiving party.

11. The method of claim 10, further comprising:
creating and encoding a preview based on the content;
providing the preview to the receiving terminal; and
transmitting the pertinent part of the encoded content according to the grade of the receiving terminal.

12. The method of claim 9, wherein the at least one source content is selected from the group consisting of a text information file, a photo image file, an audio file, and a moving image (video) file.

13. The method of claim 11, wherein the preview includes the text information file, some moving image (video) information, or photo image file used as a text information file and a representative screen.

14. The method of claim 9, further comprising:
receiving and regenerating the preview at the receiving terminal;
determining whether or not to download the whole integrated content file (IMCF) from the receiving terminal based on the selection signal created from the receiving terminal; and
providing the whole integrated content file (IMCF) to the receiving terminal in response to the selection signal.

15. A system of creating and transmitting multimedia content via a multimedia content producing/management server which can be connected with transmitting and receiving terminals through wired or wireless communication networks, the system comprising:
a source content database for storing a plurality of multimedia content (hereinafter “content”) sources;
a source content designating code database for storing a plurality of source content codes corresponding to each of the plurality of source contents;
a server for exclusive use of content creating for creating an integrated content by extracting the source content stored in the source content database according to the content constructing instruction;
an integrated central control/management module for storing the received source content to the source content database, creating a source designating code corresponding to the received source content, storing the created source designating code to the source designating code database, and creating an encoded integrated content (IMCF) by encoding the integrated content, when the source content is received through the receiving terminals, and providing the received content constructing instruction to the server for exclusive use of content creating, when the content constructing instruction from the transmitting terminals is received through the communication networks; and
a server for exclusive use of transmitting for providing the encoded integrated content (IMCF) to the receiving terminals through communication networks under the control of the integrated central control/management module.

16. The system of claim 15, wherein the content constructing instruction includes a source designator for designating at least one content source used to construct the multimedia content.

17. The system of claim 15, wherein the integrated central control/management module gives a grade to the receiving terminals according to at least one classification standard, and the at least one classification standard comprises is selected from the group consisting of a receiving capability, a regenerating capability, and a quality level requested by the receiving party.

18. The system of claim 15, wherein the server for exclusive use of content creating creates a predetermined preview based on the created integrated content, and the integrated central control/management module creates an encoded preview by encoding the preview content, providing the encoded preview content to the receiving terminals through a communication network under the control of the integrated central control/management module, and transmitting the encoded preview content according to the grade of the receiving terminals to the receiving terminal.
